(19) United States
(12) Patent Application Publication
(10) Pub. No.: US 2006/0168828 A1
(43) Pub. Date: Aug. 3, 2006

(54) Laser guided work device

(76) Inventor: Brent Dallman, Indianapolis, IN (US)

Correspondence Address: BAKER & DANIELS LLP, 300 NORTH MERIDIAN STREET, SUITE 2700, INDIANAPOLIS, IN, 46204, US

(21) Appl. No.: 11/045,410

(22) Filed: Jan. 28, 2005

(51) Int. Cl. G01C 15/00

(52) U.S. Cl. 33/286

(57) ABSTRACT

A laser guided work device including a work board having a work surface, a line producing laser projecting a line on the work surface, and a linear motion device engaging the laser to the work board. The linear motion device translates the laser relative to the work surface along at least one dimension. The line is oriented perpendicular to the at least one dimension such that the line moves relative to the work surface when the linear motion device translates the laser along the at least one dimension.

### BACKGROUND OF THE INVENTION

1. Field of the Invention.

The present invention relates to a work device that provides a work surface on which the user can write directly or position a paper for writing thereon.

2. Description of the Related Art

There are several situations in which free-hand writing is necessary or desired. For instance, free-hand writing is typically desired when writing a personal letter on personal stationary, preparing a personalized greeting card, and/or addressing an envelope. In addition, teachers, professors and other instructors must often write in free-hand when writing on a classroom chalkboard or dry erase board. Finally, the art of calligraphy also typically requires the writer to write in free-hand. Unfortunately, when writing free-hand, it is very difficult to write in a straight line. Quite often the writing moves up and/or down on the writing surface thereby resulting in an unattractive written product, which uses more writing surface space than necessary and/or may be difficult to read.

To solve this problem, many writers have resorted to drawing a straight line on the writing surface using a pencil and then erasing the pencil line after the writing is completed. Unfortunately, this method can leave unsightly eraser marks or leftover pencil marks. In addition, the eraser may smear the writing. In the classroom setting, some chalkboards have been provided with lines to guide the writer. However, these lines are permanent and their size and location cannot be adjusted according to the writer's needs. Similar problems arise in engraving, sign-making and other like activities. For instance, it is difficult for an engraver to engrave in a straight line without the guide of a line. It is also difficult for a sign-maker or graphic artist to position letters, characters or other objects on a sign, shirt, plaque or other article.

Accordingly, a need remains for a device that provides a work surface capable of guiding the user in writing in a straight line.

### SUMMARY OF THE INVENTION

The present invention, in one form thereof, is a laser guided work device including a work board having a work surface, a line producing laser projecting a line on the work surface, and a linear motion device engaging the laser to the work board. The linear motion device translates the laser relative to the work surface along at least one dimension. The line is oriented perpendicular to the at least one dimension such that the line moves relative to the work surface when the linear motion device translates the laser along the at least one dimension.

In another aspect, the present invention is a laser guided work device including a work board having a work surface and a line producing laser slidably engaged to the work board such that the laser slides relative to the work surface along at least one dimension. The laser projects a line on the work surface. A holding device positions and holds a paper against the work surface.

In yet another form, the laser guided work device includes a work board having a work surface, a line producing laser projecting a line on the work surface, a linear motion device affixed to the work board and engaging the laser to the work board, and a locator gauge. The locator gauge includes a plurality of measurement markings defined on the work surface. The markings indicate the location of the line. The linear motion device translates the laser relative to the work surface along at least one dimension. The line is oriented perpendicular to the at least one dimension such that the line moves relative to the work surface when the linear motion device translates the laser along the at least one dimension.

In another form, the present invention provides a guide device for guiding writing on a work surface of a work board. The guide device includes a linear motion device attachable to the work board and a line producing laser engaged to the linear motion device and positioned to project a line on the work surface of the workboard. The linear motion device translates the laser relative to the work surface along at least one dimension. The line is oriented perpendicular to the at least one dimension such that the line moves relative to the work surface when the linear motion device translates the laser along the at least one dimension.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of a device according to one embodiment of the present invention;

FIG. 2 is a perspective view of the device of FIG. 1 when in use;

FIG. 3 is a perspective view of a device according to another embodiment of the present invention;

FIG. 4 is a perspective view of a device according to another embodiment of the present invention;

FIG. 5 is a perspective view of the device of FIG. 4 with the laser positioned on the opposite side of the work board;

FIG. 6 is a perspective view of a portion of the device of FIG. 4;

FIG. 7 is a perspective view of an alternative embodiment for the portion shown in FIG. 6;

FIG. 8 is a perspective view of an alternative embodiment for the portion shown in FIG. 6;

FIG. 9 is a perspective view of a device according to yet another embodiment of the present invention;

FIG. 10 is a perspective view of a device according to yet another embodiment of the present invention;

FIG. 11 is a perspective view of a device according to yet another embodiment of the present invention; and

FIG. 12 is a perspective view of a device according to yet another embodiment of the present invention;

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

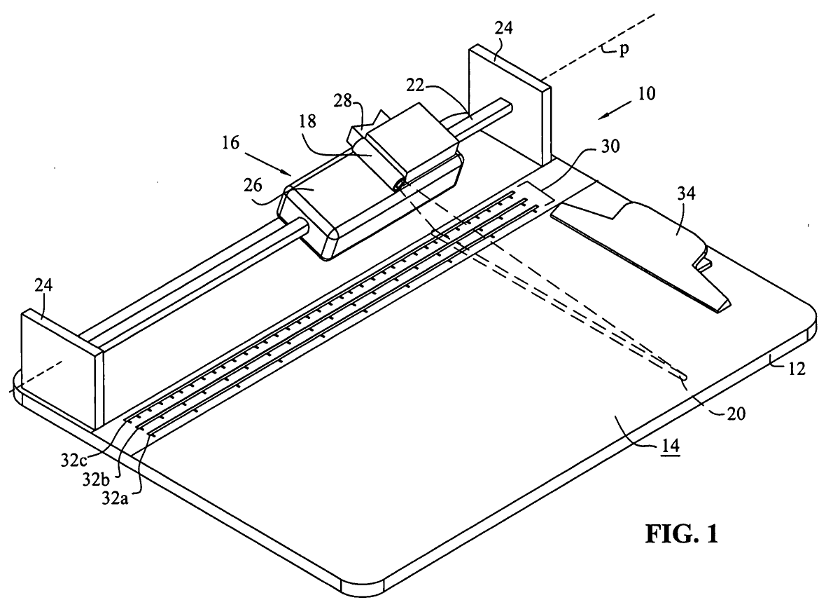

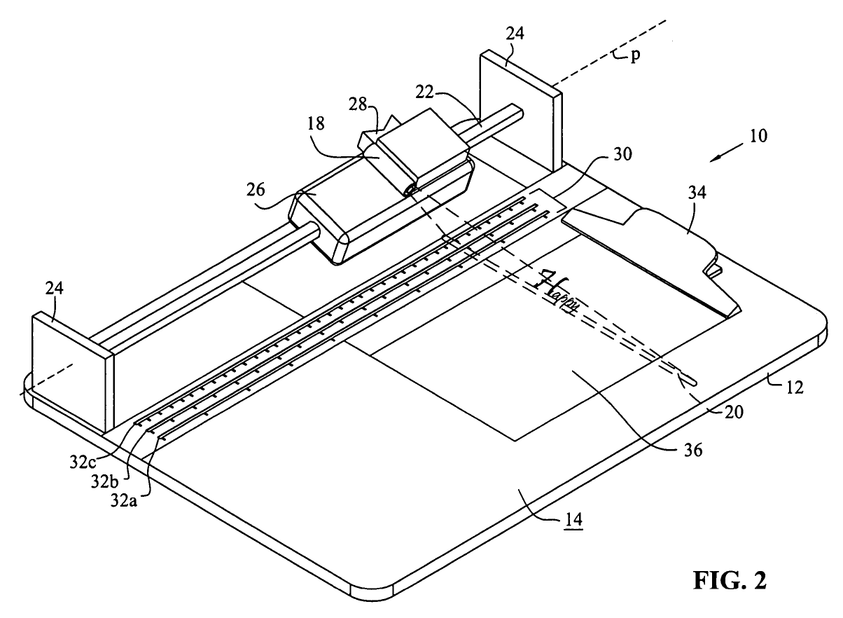

Referring first to FIGS. 1 and 2, laser guided work device 10 according to one embodiment of the present invention is illustrated. Laser guided work device 10 generally includes work board 12, laser 18 and linear motion device 16. Work board 12 is a hard, rigid structure having work surface 14. Work board 12 may be formed from any rigid material, including for example, metal, vinyl, plastic, PVC (polyvinyl chloride), wood, cardboard, glass, porcelain, or any combination thereof. Furthermore, board may be coated to provide a desired texture. For instance, work board 12 may be formed of metal with a vinyl coating to provide a smooth writing surface.

Linear motion device 16 is mounted on work board 12 and includes rail 22, rail supports 24 and trolley 26. Rail 22 is supported on work board 12 by rail supports 24, which are positioned at either end of rail 22 and are attached to work board 12. Rail 22 is aligned along dimension P, which runs along the vertical length of work board 12 and is positioned adjacent to the left edge of work board 12.

Trolley 26 is slidably engaged with rail 22 such that trolley 26 translates along dimension P relative to work board 12. Trolley 26 includes lock switch 28 which is operably coupled to a locking device (not shown) of trolley 26. Locking device is adapted to secure trolley 26 in position on rail 22 when lock switch 28 is in a locked position. Locking device permits trolley 26 to slide on rail 22 when locking switch 28 is in an unlocked position.

Laser 18 is mounted on trolley 26 for sliding movement therewith along dimension P. Laser 18 is adapted to generate a light that forms straight line 20 and is positioned to project line 20 onto work surface 14 such that line 20 is perpendicular to dimension P. Laser 18 may be any line generating laser including, for example, a laser diode module. The laser may produce any color or wavelength of light. For instance, one embodiment employs a semiconductor laser that produces a red line having a wavelength of 635-650 nm. Alternatively, lasers producing green lines and/or lines having varying wavelengths may be used. In addition, laser 18 may be powered by any means including by battery or AC.

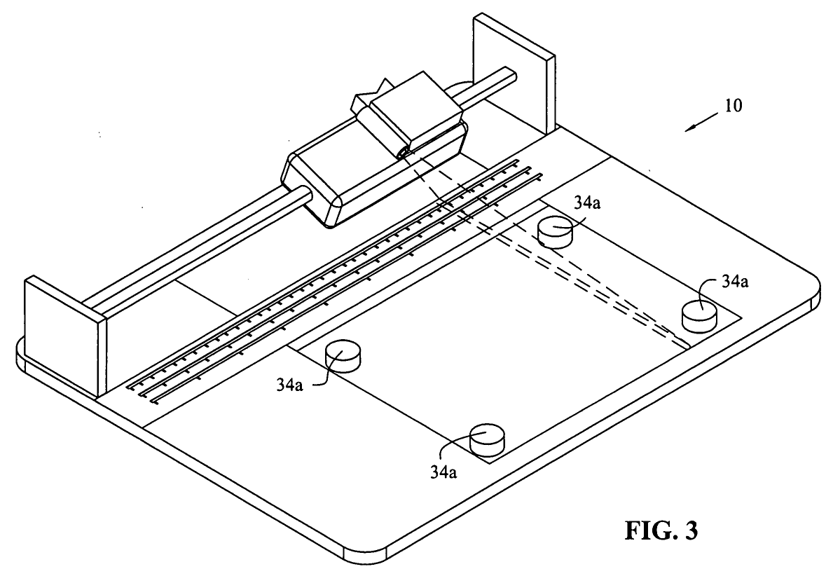

As illustrated in FIGS. 1 and 2, work board 12 also includes holding device 34 for positioning and holding paper 36 against work surface 14. Paper 36 is intended to refer generally to any object on which a straight line is needed to guide the user. For instance, paper 36 may be a sheet of stationary paper, card stock paper, standard printer paper, plastic sign board, wood (such as a wood plaque), metal or any other material on which a user would like to align objects or words. Holding device 34 may be in the form of a clip such as that on a conventional clip board. Alternatively, magnets 34a illustrated in FIG. 3, flexible band, or other device could serve as a holding device.

Work board 12 also includes line locator gauge 30 adapted to guide the user in positioning and determining the location of line 20. Gauge 30 includes measurement markings 32a, 32b, 32c imprinted or engraved on work surface 14. Measurement markings 32a, 32b, 32c may be scaled in any useful increments. For instance, markings 32a may correspond to one inch increments, markings 32b to ½ inch increments, and markings 32c to ¼ inch increments.

Referring now to FIG. 2, an exemplary use and operation of laser guided work device 10 will now be described. Device 10 may be used to make a customized birthday card. The user positions and secures a sheet of card stock paper 36 on work surface 14 using holding device 34. The user turns on laser 18 using the on/off switch (not shown). Laser 18 projects line 20 onto paper 36. The user then slides trolley 26 along rail 22 until laser line 20 is aligned with the desired measurement marking 32a-c. The user then engages locking switch 28 to lock trolley 26, and thereby line 20, in place. The user may then write the desired message, in this case the phrase “Happy Birthday,” in a straight line on paper 36 using line 20 as a guide. If a second line of writing is desired, the user unlocks locking switch 28 and slides trolley 26 until laser line 20 is aligned with the desired measurement marking 32a-c, and trolley 26 is locked in position. The user may then write the next message in a straight line spaced apart from the first message.

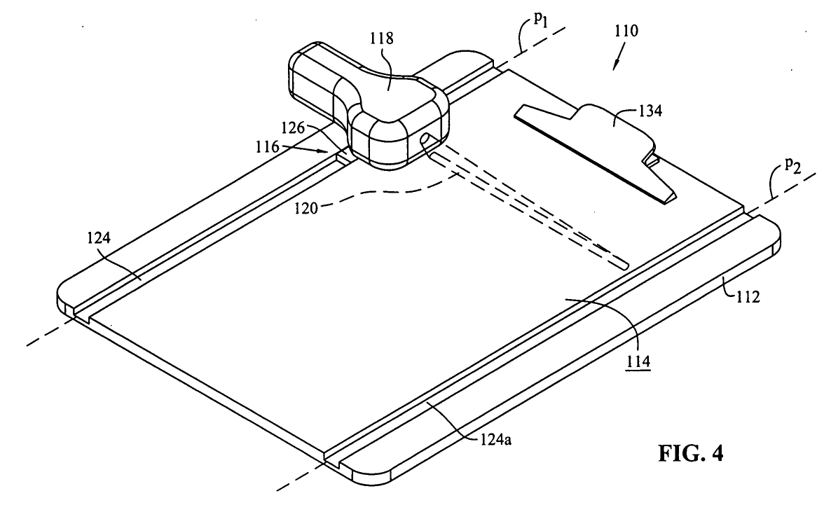

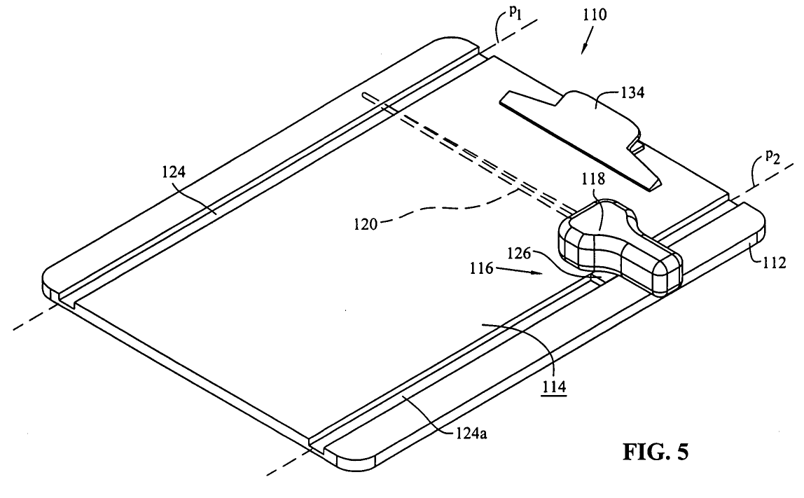

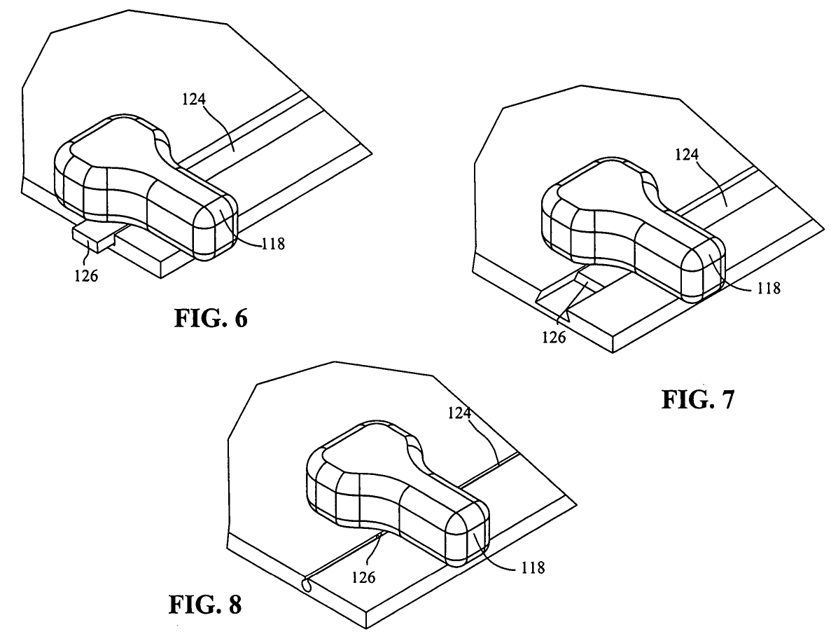

Referring now to FIG. 4, another embodiment of the present invention is illustrated. Similar to the embodiment discussed above, laser guided work device 110 generally includes work board 112, linear motion device 116, and laser 118. Work board 112 includes work surface 114. Linear motion device 116 includes groove 124 and tongue 126 slidably engaged within groove 124. Groove 124 is defined in work surface 114 of work board 112 and extends along dimension P₁, which runs vertically along the left side of work board 112. Laser 118 is mounted on tongue 126 for sliding therewith along dimension P₁ and is positioned such that it projects line 120 on work surface 114. As shown in FIGS. 4-8, groove 124 and tongue 126 have cross-sectional shapes that are complementary to one another, such that tongue 126 securely but slidably fits within groove 124. For instance, as illustrated in FIGS. 4-6, groove 124 and tongue 126 may have a rectangular cross-sectional shape. Alternatively, groove 124 and tongue 126 may have a dove-tail cross-sectional shape, as shown in FIG. 7. As shown in FIG. 8, groove 124 and tongue 126 may have a circular or keyhole cross-sectional shape. Of course, the groove and tongue may have any shape suitable for slidably securing tongue within groove.

As shown in FIGS. 4 and 5, linear motion device 116 may also include second groove 124a defined in work surface 114 and extending along dimension P₂, which runs vertically along the right side of work board 112. Tongue 126 may be slid out of groove 124 and slidably engaged within groove 124a, such that laser 118 is positioned on the right side of work board 112. Laser 118 projects line 120 on work surface 114 from its position on the right side of work board 112. This configuration simplifies use of the device by a left-handed person because the user's hand does not block the light projected by laser 118. In addition, having both grooves 124 and 124a provides versatility by accommodating either right-handed or left-handed users simply by moving laser 118/tongue 126 assembly between grooves 124 and 124a.

Although not shown above in FIGS. 1 and 2, work device 10 may also be adapted to more adequately accommodate both right-handed and left-handed users by adding another rail and rail supports on the right hand of the work board and providing a trolley that may be removed from rail 22 and repositioned on the additional rail.

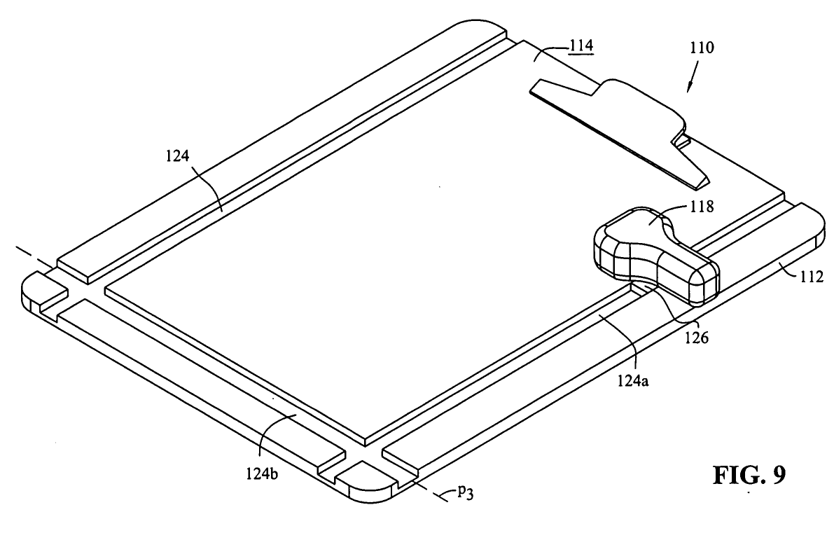

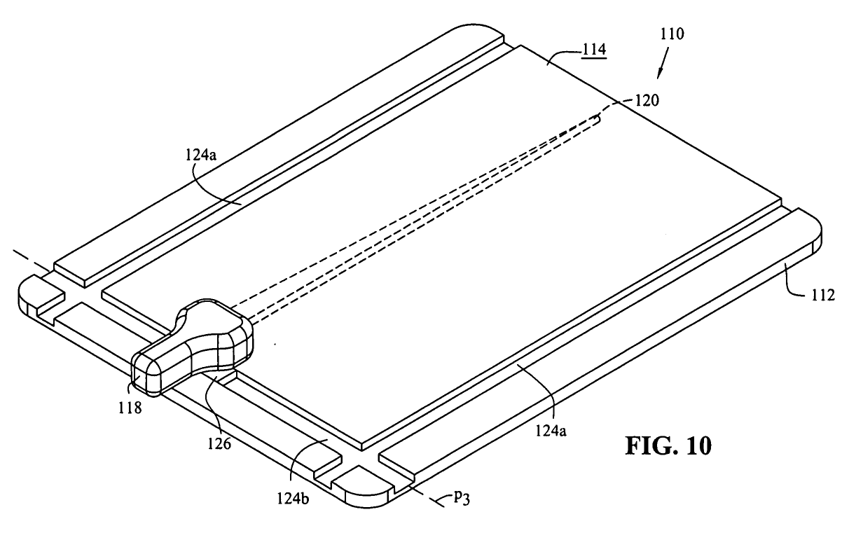

As shown in FIGS. 9-10, linear motion device 116 of laser guided work device 110 may include groove 124b defined in work surface 114 and extending along dimension P₃, which runs horizontally (perpendicular to dimension P₁) along the bottom of work board 112. Laser 118/tongue 126 assembly may be engaged with groove 124b such that line 120 is projected on work surface 114 perpendicular to dimension P₃. In this configuration, work surface 114 may be used in either a landscape orientation (with the longer length of the board extending horizontally as in FIG. 10) or in a portrait orientation (with the longer length of the board extending vertically as in FIG. 9).

Furthermore, additional laser 118/tongue 126 assemblies may be added to any of the grooves to provide multiple guiding laser lines. For instance, two lasers may be positioned in the vertical grooves to provide guide lines for the bottom and the top of the letters being written on the paper. In addition, one laser may engage the vertical groove and another may engage the horizontal groove, thereby providing a horizontal guide line and a vertical guide line. The horizontal line may guide the writing of the letters on a straight line, while the vertical line would guide the writer in the spacing between letters and words.

Although not illustrated in FIGS. 4-5 and 8-10, work device 110 may also include one or more gauges associated with one or more of dimensions P₁, P₂ or P₃.

Although the illustrated embodiments show use of only a few different types of linear motion devices, any device capable of moving the laser along the dimension is contemplated. For instance, the linear motion device may include end-supported single or double rail systems, continuously supported single or double rail systems, screw activated systems, profile rails, or other like devices.

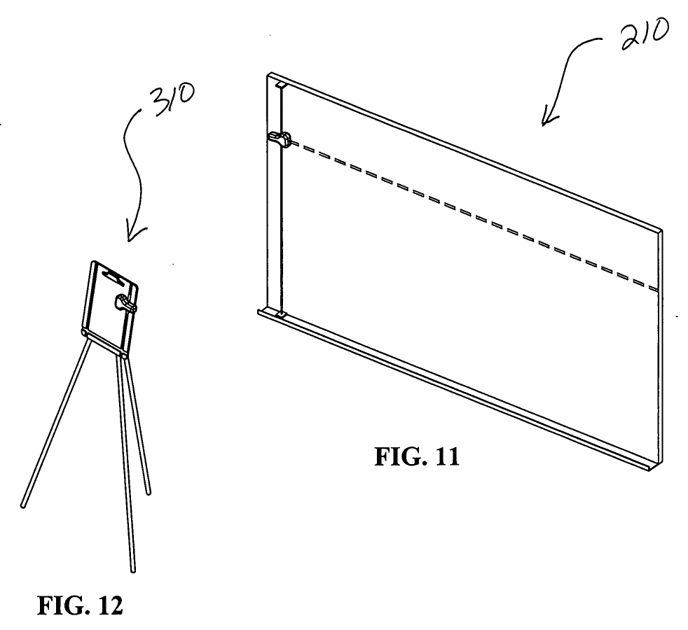

In addition to providing a laser-guided work surface for use in writing greeting cards, invitations, or letters, the device of the present application may be adapted for many uses in a variety of settings. For instance, as shown in FIG. 11, device 210 may be used in a classroom or other instructional setting. In this case, the work board may be adapted for mounting on a wall, an easel or rolling stand. The work board may be formed of any material that provides a surface on which the user can directly write. For instance, the work board may be formed of a plastic-coated material, as in a dry erase board, or of a porcelain coated material, as in a chalk board. In this case, the work board does not need the holding device. A similar device may be used as an erasable menu board at a restaurant. The work board may also be adapted for use as a laptop, table top, or easel mount device (FIG. 12, 310). It may be used as a work surface on which a sign may be made. The laser line may be used to guide the placement of letters and characters on the sign. The device may also be adapted for use in drafting. In this case, the laser may be configured to adjust the angle of the laser line.

In another embodiment, both the laser and the linear motion device may be sold together in an assembly separate from the work board. In this case, the linear motion device might resemble linear motion device 16 of FIGS. 1 and 2, except that rail supports 24 would include or be replaced by fasteners designed to be permanently or removably fastened to a work board. For instance, rail supports may include suction cups or brackets designed to removably attach the linear motion device 16 to a work board, such as a chalk board. Alternatively, the linear motion device may be configured to be clamped on in a fashion similar to conventional adjustable spreader/bar clamps. In this case, the bar of the clamp would serve as the rail to which the trolley and laser are slideably mounted. A clamp would be attached to each end of the rail and at least one clamp would be slidably attached to the rail. The slidable clamp would slide along the rail until both clamps firmly bear against the edge of the board thereby mounting the rail to the board. The slidable clamp would also allow the accommodation of various board sizes. In this embodiment, the laser/linear motion device could be removably attachable to a work board thereby providing portability and accommodating various types of work boards. Furthermore, the removably attachable laser/linear assembly could be retrofit to existing work boards, such as chalkboards and dry erase boards.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A laser guided work device for guiding the alignment of a user's writing, the device comprising:
a work board having a work surface;
a line producing laser projecting a line on said work surface; and
a linear motion device engaging said laser to said work board, said linear motion device translating said laser relative to said work surface along at least one dimension, said line oriented perpendicular to said at least one dimension such that said line moves relative to said work surface when said linear motion device translates said laser along said at least one dimension.

2. The laser guided work device of claim 1 wherein said at least one dimension includes a first dimension and said linear motion device comprises a rail and a trolley, said rail attached to said work board and extending along said first dimension, said trolley is slideably engaged with said rail and said laser is attached to said trolley for movement along said first dimension.

3. The laser guided work device of claim 1 wherein said linear motion device comprises a groove defined on said work board and extending along said at least one dimension and a tongue slidably engaged within said groove, said laser mounted on said tongue for sliding movement along said at least one dimension.

4. The laser guided work device of claim 1 wherein said at least one dimension includes a first dimension and a second dimension perpendicular to said first dimension; said linear motion device comprising a first groove, a second groove and a tongue, said first and second grooves defined on said work board and extending along said first and second dimensions respectively; said tongue being slidably engaged with either one of said first and second grooves for movement along either of said first and second dimensions respectively, and said laser being attached to said tongue for movement with said trolley.

5. The laser guided work device of claim 3 further comprising a second line producing laser and wherein said linear motion device comprises a second tongue, said second tongue slidably engaged with either of said first and second grooves for movement along either of said first and second dimensions respectively, said second laser being attached to said second tongue for movement with said second tongue.

6. The laser guided work device of claim 3 wherein each of said tongue and groove has a dove-tail cross-sectional shape complementary with one another.

7. The laser guided work device of claim 3 wherein each of said tongue and groove has a circular cross-sectional shape complementary with one another.

8. The laser guided work device of claim 1 wherein said work board includes a laser line locator gauge comprising a plurality of measurement markings on said work surface, said markings indicating the location of said line.

9. The laser guided work device of claim 1 wherein said work board includes a paper holding device for positioning and holding a paper against said work surface.

10. The laser guided work device of claim 1 wherein said holding device includes a clip biased against said work surface.

11. The laser guided work device of claim 9 wherein said work board comprises metal and said holding device includes at least one magnet.

12. The laser guided work device of claim 1 wherein said laser is battery powered.

13. The laser guided work device of claim 1 wherein said laser is powered by AC current.

14. The laser guided work device of claim 1 wherein said work surface is a writing board.

15. A laser guided work device for guiding the alignment of a user's writing, the device comprising:
a work board having a work surface;
a line producing laser slidably engaged to said work board such that said laser slides relative to said work surface along at least one dimension, said laser projecting a line on said work surface; and
a holding device for positioning and holding a paper against said work surface.

16. The laser guided work device of claim 15 wherein said work board includes a rail extending along said at least one dimension, and a trolley is slidably engaged with said rail for movement along said at least one dimension and said laser is attached to said trolley for movement along said at least one dimension.

17. The laser guided work device of claim 15 further comprising a second line producing laser slidably engaged to said work board such that said second laser slides relative to said work surface along said at least one dimension, said laser projecting a line on said work surface, said line being perpendicular to said at least one dimension.

18. The laser guided work device of claim 15 wherein said work board includes a groove defined on said work surface and extending along said at least one dimension, a tongue is slidably engaged within said groove, said laser is mounted on said tongue for sliding movement along said at least one dimension.

19. The laser guided work device of claim 18 wherein said at least one dimension includes a first dimension and a second dimension perpendicular to said first dimension, said work board includes a first groove extending along said first dimension and a second groove extending along said second dimension, said tongue being slidably engaged with either one of said first and second grooves for movement along either of said first and second dimensions respectively, and said laser being attached to said tongue for movement with said tongue.

20. The laser guided work device of claim 18 wherein said at least one dimension includes a first dimension and a second dimension parallel to said first dimension, said work board includes a first groove extending along said first dimension and a second groove extending along said second dimension, said tongue being slidably engaged with either one of said first and second grooves for movement along either of said first and second dimensions respectively, and said laser being attached to said tongue for movement with said tongue.

21. The laser guided work device of claim 18 wherein each of said tongue and groove has a dove-tail cross-sectional shape complementary with one another.

22. The laser guided work device of claim 18 wherein each of said tongue and groove has a circular cross-sectional shape complementary with one another.

23. The laser guided work device of claim 15 wherein said work board includes a laser line locator gauge comprising a plurality of measurement markings on said work surface, said markings indicating the location of said line.

24. The laser guided work device of claim 15 wherein said holding device includes a clip biased against said work surface.

25. The laser guided work device of claim 15 wherein said work board comprises metal and said holding device includes at least one magnet.

26. A laser guided work device for guiding the alignment of a user's writing, the device comprising:
a work board having a work surface;
a line producing laser projecting a line on said work surface;
a linear motion device affixed to said work board and engaging said laser to said work board, said linear motion device translating said laser relative to said work surface along at least one dimension, said line oriented perpendicular to said at least one dimension such that said line moves relative to said work surface when said linear motion device translates said laser along said at least one dimension; and
a locator gauge comprising a plurality of measurement markings defined on said work surface, said markings indicating the location of said line.

27. A guide device for guiding writing on a work surface of a work board, the guide device comprising:
a linear motion device attachable to the work board; and
a line producing laser engaged to said linear motion device and positioned to project a line on the work surface of the workboard, said linear motion device translating said laser relative to the work surface along at least one dimension, said line oriented perpendicular to said at least one dimension such that said line moves relative to said work surface when said linear motion device translates said laser along said at least one dimension.
